(19) United States
(12) Patent Application Publication
(10) Pub. No.: US 2023/0411935 A1
(43) Pub. Date: Dec. 21, 2023

(54) CONFIGURABLE ELECTRICAL BYPASS SWITCHING APPARATUS

(71) Applicant: Eaton Intelligent Power Limited, Dublin (IE)

(72) Inventors: Alexander F. Groth, Milwaukee, WI (US); Nicholas J. Wainio, Wales, WI (US); Kyle Perea, Billings, MT (US)

(21) Appl. No.: 18/197,343

(22) Filed: May 15, 2023

Related U.S. Application Data
(60) Provisional application No. 63/352,726, filed on Jun. 16, 2022.

(51) Int. Cl. H02B 1/20; H01R 13/53

(52) U.S. Cl. CPC H02B 1/20; H01R 13/53

(57) ABSTRACT

A system includes: a switching apparatus including a plurality of electrically isolated busbars, each busbar including at least a first interface and a second interface; a first type of separable electrical connector configured to mechanically and electrically connect to one of the first interfaces; and a second type of separable electrical connector configured to connect to two of the second interfaces simultaneously. The switching apparatus is configurable to have one of a plurality of current paths based on which two of the second interfaces are electrically and mechanically connected to the second type of separable electrical connector.

### CROSS-REFERENCE TO RELATED APPLICATION

This application claims the benefit of U.S. Provisional Application No. 63/352,726, filed on Jun. 16, 2022 and titled CONFIGURABLE ELECTRICAL BYPASS SWITCHING APPARATUS, which is incorporated herein by reference in its entirety.

### TECHNICAL FIELD

This disclosure relates to a configurable electrical bypass switching apparatus.

### BACKGROUND

An electrical connector is used to connect electrical transmission and distribution equipment and electrical sources within an electrical power distribution system.

### SUMMARY

In one aspect, a system includes: a switching apparatus including a plurality of electrically isolated busbars, each busbar including at least a first interface and a second interface; a first type of separable electrical connector configured to mechanically and electrically connect to one of the first interfaces; and a second type of separable electrical connector configured to connect to two of the second interfaces simultaneously. The switching apparatus is configurable to have one of a plurality of current paths based on which two of the second interfaces are electrically and mechanically connected to the second type of separable electrical connector.

Implementations may include one or more of the following features.

The system also may include a base portion, the base portion being an electrically conductive material, and the plurality of busbars may be attached to the base portion and electrically isolated from the base portion. The base portion may include a plurality of bays, and each busbar may be in a separate bay. Each bay may be defined by walls that extend from the base portion. In some implementations, the system also includes a cover portion configured for placement over the bays, the cover portion has a plurality of openings; and when the cover portion is placed over the bays, at least some of the openings are over intersection points of the walls to thereby provide a visible indicator of the current path.

The second type of electrical connector may include: a first electrical probe; a second electrical probe; an electrical conductor that electrically connects the first electrical probe and the second electrical probe; and an insulating housing that defines a first connector interface and a second connector interface. The first connector interface may be configured to attach to one of the second interfaces of the switching apparatus to thereby electrically connect the first electrical probe to a first one of the second interfaces; and the second connector interface may be configured to attach to a second one of the second interfaces of the switching apparatus to thereby electrically connect the second electrical probe to the second one of the second interfaces and to electrically connect the busbar that includes the first one of the second interfaces to the busbar that includes second one of the second interfaces. The second type of electrical connector may be a C-shape or a U-shape electrical connector. The first type of electrical connector may be an elbow arrester.

In some implementations, the system also includes an electrically insulating material between each busbar.

The plurality of current paths may include: a standard current path that connects a device to a source and a load; a transition current path that provides a low-impedance current path between the source and the load and a high-impedance current path to the device; and a bypass current path that connects the source to the load without being connected to the device.

The first interface may be a deadbreak interface configured to connect to a separable deadbreak connector or a loadbreak interface configured to connect to a loadbreak connector. The first interface and the second interface may be rated to conduct current of up to 200 Amperes (A), current up to 600 A, or current of up to 1250 A.

The first interface may be a deadbreak bushing. The second interface may be rated to conduct current of up to 200 A or up to 600 A.

The plurality of busbars may include a first busbar, a second busbar, a third busbar, and a fourth busbar; the first busbar, the second busbar, the third busbar, and the fourth busbar may be arranged such that the second electrical connector is attachable to more than one adjacent pair of second interfaces, and two second interfaces that are nearest to each other form an adjacent pair of second interfaces.

The plurality of busbars may include first and second busbars; and each of the first and second busbars may include two first interfaces and one second interface.

The plurality of busbars may include a first busbar, a second busbar, a third busbar, and a fourth busbar; each of the first and second busbars may include one first interface and two second interfaces; and each of the third and fourth busbars may include one first interface and one second interface.

In another aspect, a switching apparatus includes: a base portion; a first electrical conductor attached to the base portion; and a second electrical conductor attached to the base portion and electrically isolated from the first electrical conductor. Each of the first electrical conductor and the second electrical conductor is electrically isolated from the base portion, each of the first electrical conductor and the second electrical conductor includes: at least one first type interface configured to electrically and mechanically connect to a first type of separable electrical connector, and at least one second type interface configured to electrically and mechanically connect to a second type of separable electrical connector. The switching apparatus is configurable to have one of a plurality of current paths based on which of the second type interfaces are electrically and mechanically connected to a second type of separable electrical connector.

Implementations may include one or more of the following features.

The plurality of current paths may include: a standard current path that connects a device to a source and a load; a transition current path that provides a low-impedance current path between the source and the load and a high-impedance current path to the device; and a bypass current path that connects the source to the load without being connected to the device.

In some implementations, the switching apparatus also includes a third electrical conductor attached to the base portion and electrically isolated from the base portion, the third electrical conductor including at least one of the first type interface and at least one of the second type interface; and a fourth electrical conductor attached to the base portion and electrically isolated from the base portion, the fourth electrical conductor including least one of the first type interface and at least one of the second type interface.

The first interface may include a first bushing, and the second interface may include a second bushing.

The first electrical conductor may be a first busbar, and the second electrical conductor may be a second busbar.

In another aspect, a source is electrically connected to a switch assembly by connecting a first separable electrical connector to a first type interface on a first electrical conductor; a load is electrically connected to the switch assembly by connecting a second separable electrical connector to a first type interface on a second electrical conductor; a device is electrically connected between the source and the load by connecting a third electrical connector and a fourth electrical connector to the switch assembly. Connecting the third electrical connector to the switch assembly includes connecting the third electrical connector to a second type interface on the first electrical conductor and to a second type interface on a third electrical conductor, and connecting the fourth electrical connector to the switch assembly includes connecting the fourth electrical connector to a second type interface on a fourth electrical conductor and to a second type interface on the second electrical conductor. The device is bypassed by connecting a fifth electrical connector to a second type interface on the first electrical conductor to a second type interface on the second electrical conductor; and after connecting the fifth electrical connector, disconnecting the third electrical connector and the fourth electrical connector from the switch assembly.

Implementations of any of the techniques described herein may include a system, an assembly, a switching apparatus, and/or a method. The details of one or more implementations are set forth in the accompanying drawings and the description below. Other features will be apparent from the description and drawings, and from the claims.

### DRAWING DESCRIPTION

FIG. 1A is a block diagram of an alternating current (AC) electrical power distribution system that includes a switching system that is in a standard mode.

FIG. 1B is a block diagram of the AC electrical power distribution system of FIG. 1A with the switching system in a bypass mode.

FIG. 2A a top view of a base portion of an example of a switching apparatus.

FIG. 2B is a cross-sectional view of the base portion of FIG. 2A

FIG. 2C is a more detailed top view of a busbar attached to the base portion of FIG. 2A.

FIG. 3A is a cross-sectional side view of an example of a first type of separable electrical connector.

FIG. 3B is an exterior view of the connector of FIG. 3A.

FIG. 3C is a cross-sectional side view of an example of a second type of separable electrical connector.

FIG. 3D is an exterior view of the connector of FIG. 3C.

FIG. 4 shows the first separable electrical connector of FIGS. 3A and 3B and the second type of separable electrical connector of FIGS. 3C and 3D with the switching apparatus of FIG. 2A.

FIGS. 5A-5C show various current paths through the switching apparatus.

FIG. 6 is a block diagram of another example of a switching apparatus.

FIG. 7 is a block diagram of another example of a switching apparatus.

FIG. 8 is a block diagram of another example of a switching apparatus.

FIG. 9 is an example of a switching apparatus cover.

### DETAILED DESCRIPTION

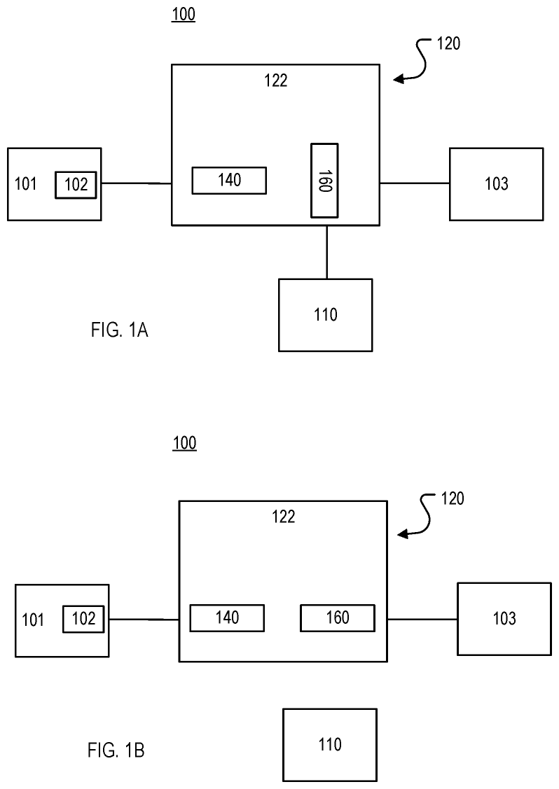

FIGS. 1A and 1B are block diagrams of an alternating current (AC) electrical power distribution system 100 that includes a switching system 120. The switching system 120 is configurable to be in a standard mode (FIG. 1A) or a bypass mode (FIG. 1B). The switching system 120 includes a switching apparatus 122, a first separable electrical connector 140, and a second separable electrical connector 160. The switching apparatus 122 is configured such that the switching system 120 may be used in the standard mode or the bypass mode based on the manner in which the connectors 140 and 160 are attached to the apparatus 122.

Each separable electrical connector 140 and 160 may be a loadbreak or deadbreak connector or arrester configured to interrupt up to 200 Amperes (A) or up to 600 A of electrical current and may have a rated voltage of up to 15 kilovolts (kV), up to 25 kV, or up to 35 kV. These current and voltage values are provided as examples, and the switching system 120 may be used with electrical connectors having different rated currents and/or voltages.

The electrical connectors 140 and 160 are separable and movable electrical connectors that may be repeatedly connected to and disconnected from the switching apparatus 122. The separable electrical connectors 140 and 160 are configured to be moved by a human operator and/or with a hotstick. The electrical connector 140 may be, for example, a loadbreak elbow connector, deadbreak elbow connector, a loadbreak T-body, or a deadbreak T-body T-connector. The electrical connector 140 may be a U-shaped connector or a C-shaped connector.

The electrical connectors 140 and 160 may be connected to the apparatus 122 in more than one way such that the current path or paths through the switching system 120 are configurable. In this way, the switching system 120 may be used to electrically connect a device 110 to an AC source 102 and a load 103 (as shown in FIG. 1A) or to bypass the device 110 (as shown in FIG. 1B). The arrangement of the switching system 120 allows the system 120 to be used as a bypass switch with a make-before-break option, meaning that a second connection to the load 103 and/or the source 102 is made prior to breaking the electrical connection to the device 110. Moreover, the switching system 120 has a deadfront and provides a design that is safe for interaction with a human user or equipment operated by a human user. Furthermore, the switching system 120 is more compact than legacy bypass switches.

Before discussing various implementations and aspects of the switching system 120 in more detail, an overview of the system 100 is provided.

The device 110 is any type of device or system that utilizes electricity. The device 110 may be, for example, a voltage regulator, a transformer, a switching apparatus, a junction, or a sectionalizing cabinet. The AC power grid 101 is a three-phase power grid that operates at a fundamental frequency of, for example, 50 or 60 Hertz (Hz). The power grid 101 includes devices, systems, and components that transfer, distribute, generate, and/or absorb electricity. For example, the power grid 101 may include, without limitation, generators, power plants, electrical substations, transformers, renewable energy sources, distributed energy sources (DERs), transmission lines, reclosers and switchgear, fuses, surge arresters, combinations of such devices, and any other device used to transfer or distribute electricity. A DER is an electricity-producing resource and/or a controllable load. Examples of DER include, for example, solar-based energy sources such as, for example, solar panels and solar arrays; wind-based energy sources, such as, for example, wind turbines and windmills; combined heat and power plants; rechargeable sources (such as batteries); natural gas-fueled generators; electric vehicles; and controllable loads, such as, for example, some heating, ventilation, air conditioning (HVAC) systems and electric water heaters.

The power grid 101 may be low-voltage (for example, up to 5 kilovolts (kV)), medium-voltage or distribution voltage (for example, between 5 kV and 46 kV), or high-voltage (for example, 46 kV and greater). The power grid 101 may include more than one sub-grid or portion. For example, the power grid 101 may include AC micro-grids, AC area networks, or AC spot networks that serve particular customers. These sub-grids may be connected to each other via switches and/or other devices to form the grid 101. Moreover, sub-grids within the grid 101 may have different nominal voltages. For example, the grid 101 may include a medium-voltage portion connected to a low-voltage portion through a distribution transformer. All or part of the power grid 101 may be underground.

The source 102 may be any type of AC power source. The source 102 may be, for example, a generator or a DER. Furthermore, the source 102 may be a portion of the AC power grid 101 that is not necessarily an active source of electrical power. For example, the source 102 may be a transformer that is electrically connected to an upstream power source.

The load 103 may be any device that uses, transfers, or distributes electricity in a residential, industrial, or commercial setting, and the load 103 may include more than one device. For example, the load 103 may be a motor, an uninterruptable power supply, or a lighting system. The load 103 may be a device that connects to another portion of the power grid 101. For example, the load 103 may be a recloser or switchgear, another transformer, or a point of common coupling (PCC) that provides an AC bus for more than one discrete load. The load 103 may include one or more DERs. The load 103 may provide electricity to the AC grid 101. Moreover, the load 103 may be part of the AC grid 101, and the switching system 120 may be part of the AC grid 101. In some implementations, the load 103 is a ground point.

Moreover, the electrical power system 100 may include additional components and systems that are not shown or discussed above. For example, the electrical power system 100 may include cabinets, transformers, transmission lines and cables, substations, and support structures, just to name a few. All or part of the electrical power system 100 may be underground. The switching system 120 may be used in an underground electrical distribution system, in either a pad mount or wholly underground manner.

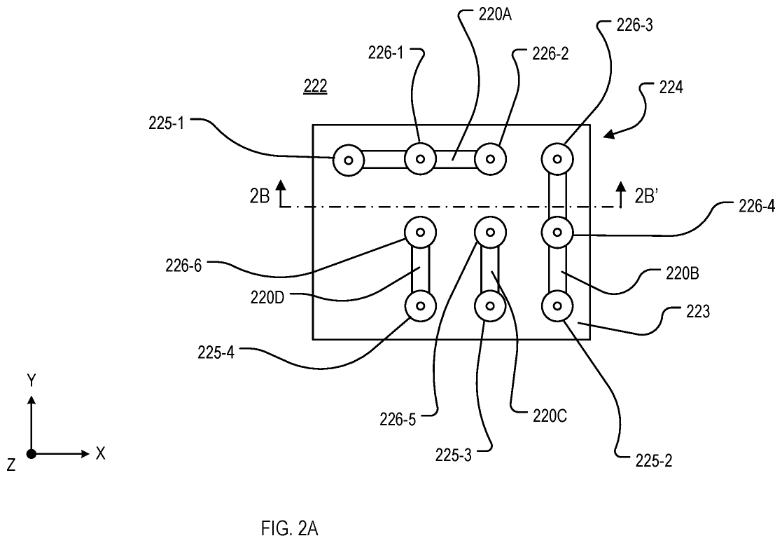

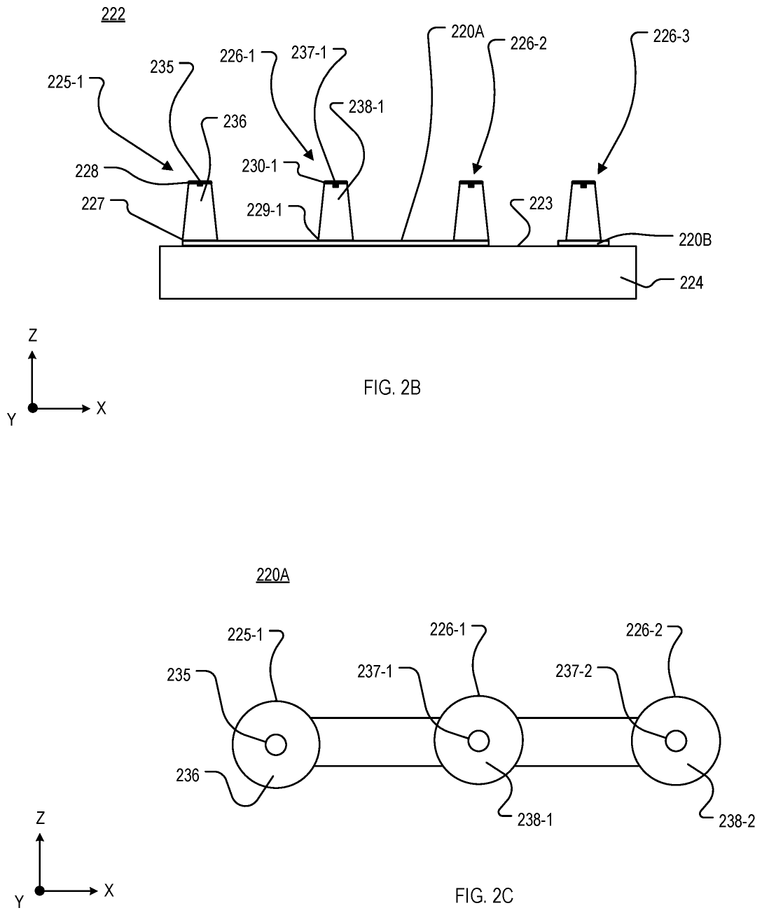

Referring to FIG. 2A, a top view of a base portion 224 of a switching apparatus 222 is shown. FIG. 2B is a cross-sectional view of the base portion 224 taken along line 2B-2B′. FIG. 2C is a more detailed top view of the busbar 220A. The switching apparatus 222 may be used in the switching system 120 (FIGS. 1A and 1B).

The base portion 224 is made of a sturdy and solid material, such as, for example, steel, aluminum, or a polymer. The base portion 224 may be or may include a bracket (not shown) configured for mounting to a separate structure, such as a cabinet or utility structure. The bracket may be a flange or other feature that allows the base portion 224 to be mounted or attached to a separate structure. The bracket may be made of stainless steel.

The base portion 224 includes a surface 223 that extends generally in the X-Y plane and busbars 220A, 220B, 220C, and 220D that are attached to the surface 223. The busbars 220A, 220B, 220C, 220D may be attached to the surface 223 in any manner that ensures a secure connection. For example, the busbars 220A, 220B, 220C, and 220D may be bolted, screwed onto, and/or adhered to the surface 223.

The busbars 220A-220D are electrically conductive bars or blocks of material. For example, each busbar 220A-220D may be a block, bar, conduit, wire, or rod of metal or metal alloy. In the example shown in FIGS. 2A-2C, the busbars 220A-220B are rigid bars of electrically conductive material. Examples of materials that may be used for the busbars 220A-220D include, without limitation, brass, copper, silver, gold, tin, and aluminum.

The surface 223 is electrical isolated from the busbars 220A-220D such that the surface 223 and the base portion 224 are not energized when any of the busbars 220A-220D are energized. For example, in implementations in which the base portion 224 and the surface 223 are made of an electrically conductive material, an insulator (such as rubber or another polymer) is between the busbars 220A-220D and the surface 223

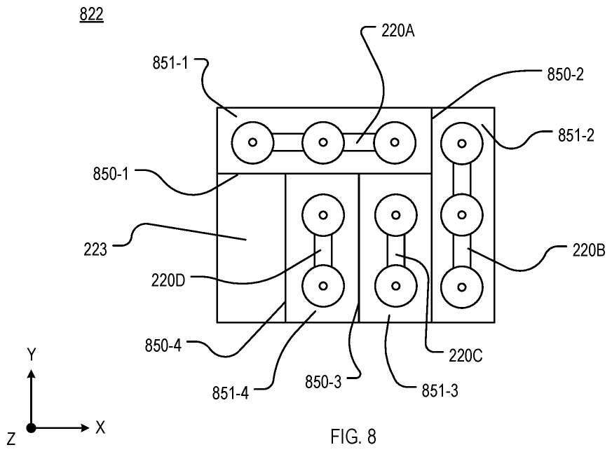

The busbars 220A-220D are electrically isolated from each other. In the example shown in FIG. 2A, the busbars 220A-220D are electrically isolated from each other due to physical distance. In some implementations, each of the busbars 220A-220D is overmolded, coated, encapsulated, encased, or otherwise covered with an electrically insulating material to provide additional electrical isolation. The insulating material may be, for example, a dielectric material such as ceramic, mica, plastic, rubber, an elastomer, or a metal oxide. Ethylene propylene diene monomer (EPDM) is a specific example of a material that may be used to insulate the busbars 220A-220D, but other materials may be used. In implementations in which the busbars 220A-220D are covered with an electrically insulating material, the electrically insulating material provides electrical isolation between the busbars 220A-220D and the surface 223 of the base portion 224. In these implementations, the busbars 220A-220D may be bolted or attached to the surface 223 with a fastener that is also electrically isolated from the busbars 220A-220D. In implementations in which the electrically insulating material is compressible, the electrically insulating material may become compressed when the busbars 220A-220D are attached to the surface, but the material still provides electrical isolation between the busbars 220A-220D and the surface 223. Moreover, each busbar 220A-220D may be in a separate bay to provide further electrical isolation between the various busbars 220A-220D, such as shown in FIG. 8.

The switching apparatus 222 also includes a plurality interfaces, each of which is electrically connected to one of the busbars 220A-220D. The interfaces include two types of interfaces, each of which is configured for connection to a different type of separable electrical connector. The interfaces include first type interfaces 225-1, 225-2, 225-3, and 225-4, (collectively referred to as first type interfaces 225) and second type interfaces 226-1, 226-2, 226-3, 226-4, 226-5, and 226-6 (collectively referred to as second type interfaces 226). All of the first type interfaces 225 are identically configured. All of the second type interfaces 226 are identically configured. The first type interface 225-1 and the second type interface 226-1 are discussed as examples below.

Referring also to FIGS. 2B and 2C, the first type interface 225-1 includes an electrically insulating body or housing 236 that extends in the Z direction from a first end 227 to a second end 228. The insulating housing 236 surrounds a conductor 235. The electrically insulating housing 236 prevents or reduces electrical interaction, such as arcing, between the conductor 235 and nearby electrical conductors. The insulating housing 236 is tapered, and the diameter of the housing 236 in the X-Y plane at the first end 227 is the greater than the diameter of the insulating housing 236 at the second end 228.

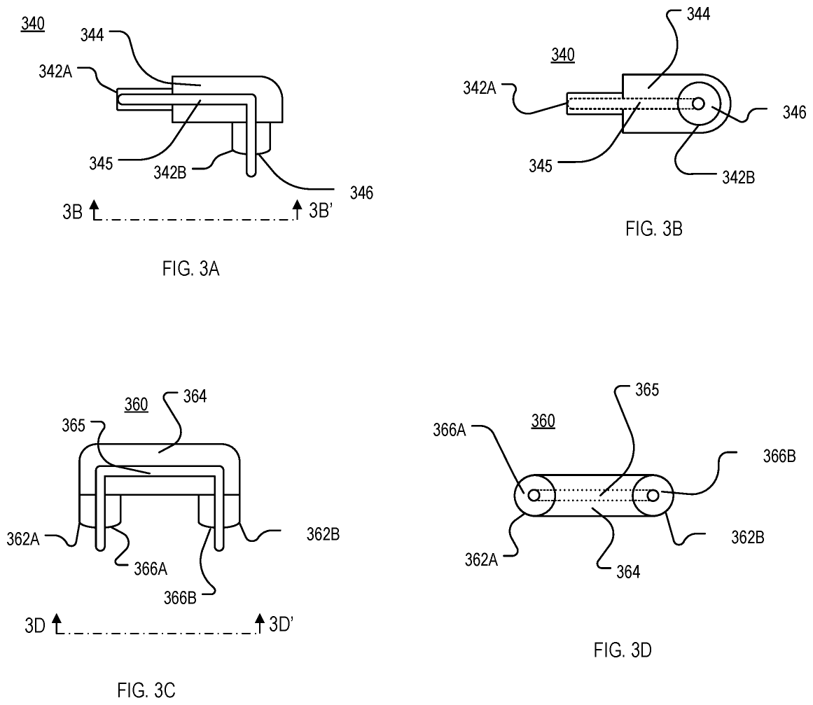

The conductor 235 is accessible from the second end 228 such that the conductor 235 may be electrically connected to an external device (such as the first type of separable electrical connector 340 of FIGS. 3A and 3B). The conductor 235 is electrically connected to the busbar 220A. Thus, when an external device is electrically connected to the conductor 235, that external device is also electrically connected to the busbar 220A. The other first type interfaces 225 are identical to the first type interface 225-1.

The second type interface 226-1 includes an electrically insulating body or housing 238-1 that extends in the Z direction from a first end 229-1 to a second end 230-1. The insulating housing 238-1 surrounds a conductor 237-1. The insulating housing 238-1 is tapered in the Z direction, and diameter of the electrically insulating housing 238-1 at the first end 229-1 is greater than the diameter of the insulating housing 238-1 at the second end 230-1.

The conductor 237-1 is accessible from the second end 230-1 to allow the conductor 237-1 to be electrically connected to an external device (such as the second type of separable electrical connector 360 of FIGS. 3C and 3D). The conductor 237-1 is electrically connected to the busbar 220A. When an external device is electrically connected to the conductor 237-1, the external device is also electrically connected to the busbar 220A. The other second type interfaces 226 are identical to the second type interface 226-1.

The first type interfaces 225 and the second type interfaces 226 may be rated for 200 Amperes (A), 600 A, or up to 1250 A of electrical current and up to 15 kilovolts (kV) or up to 35 kV.

The configuration of the insulating housings of the interfaces 225 and 226 are provided as examples, and other implementations are possible. Moreover, the specific shape of the insulating housings of the interfaces 225 and 226 depends on the configuration of the separable electrical connector intended for connection to the first type interfaces 225 and the second type interfaces 226.

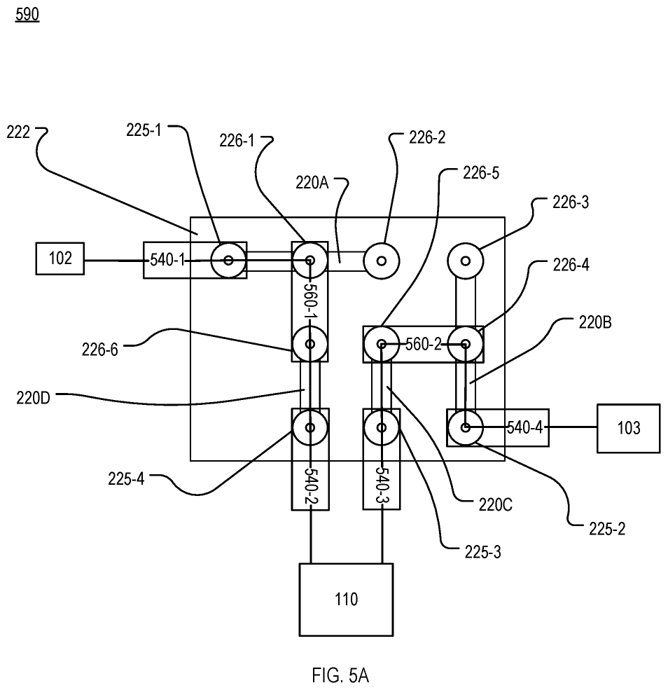

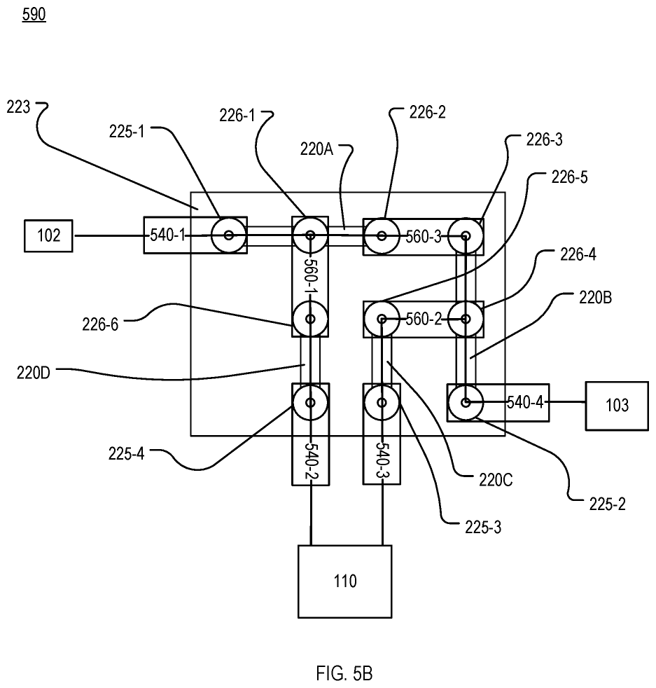

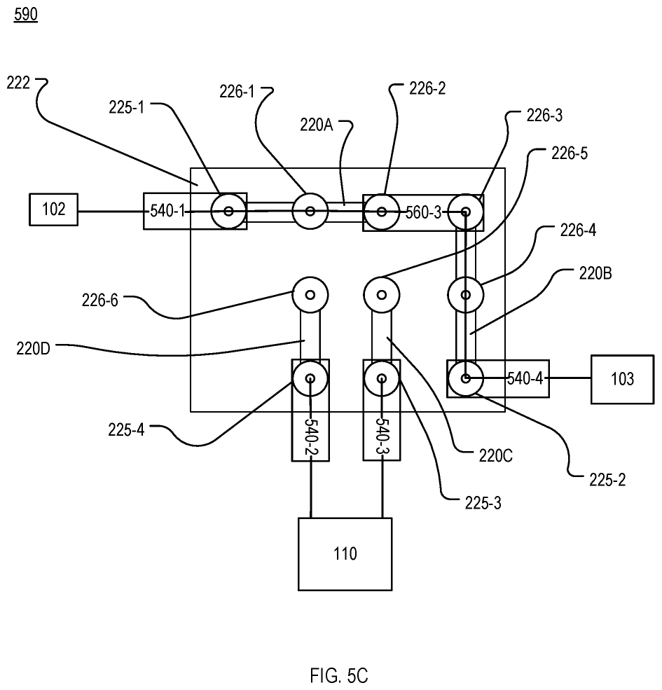

Referring again to FIG. 2A, each busbar 220A and 220B is a three-way junction that includes one first type interface 225 and two second type interfaces 226. Each busbar 220C and 220D is a two-way junction that includes one first type interface 225 and one second type interface 226. Specifically, the busbar 220A includes the interfaces 225-1, 226-1, and 226-2. The busbar 220B includes the interfaces 225-2, 226-3, and 226-4. The busbar 220C includes the interfaces 225-3 and 226-5. The busbar 220D includes the interfaces 225-4 and 226-6. The electrical connection between the various distinct busbars 220A, 220B, 220C, 220D is controlled by placement of separable electrical connectors, as discussed with respect to FIG. 5A-5C.

FIG. 3A is a cross-sectional side view of a first type of separable electrical connector 340. FIG. 3B is an exterior view of the connector 340 as seen from the direction indicated by the line 3B-3B′.

The first type of separable electrical connector 340 includes an electrically insulating housing 344 and a conductor 345 inside the housing 344. The conductor 345 is shown in a dashed line style in FIG. 3B to indicate that it is a hidden element when the electrical connector 340 is viewed from the exterior. The housing 344 extends from an end 342A to an end 342B and has an elbow shape. The housing 344 may have other shapes in other implementations. The end 342B defines a recess 346. The conductor 345 extends into the recess 346. The recess 346 is the same shape as the interfaces 225, and the diameter of the recess 346 is slightly smaller than the diameter of the interfaces 225. The end 342B is made of a material that is not completely rigid such that the recess 346 is able to fit over the interface 225 to mechanically connect the electrical connector 340 to the interface 225. After being mounted to the interface 225, the recess 346 compresses around the exterior of the interface 225, thus helping to maintain a proper electrical connection between the electrical connector 340 and the interface 225.

FIG. 3C is a cross-sectional side view of a second type of separable electrical connector 360. FIG. 3D is an exterior view of the connector 360 as seen from the direction indicated by the line 3D-3D′.

The second type of separable electrical connector 360 includes an electrically insulating housing 364 and a conductor 365 inside the housing 364. The conductor 365 is shown in a dashed line style in FIG. 3D to indicate that it is a hidden element when the electrical connector 360 is viewed from the exterior. The housing 364 extends from an end 362A to an end 362B and has a U-shape. The end 362A defines a recess 366A, and the end 362B defines a recess 366B. Each recess 366A and 366B is the same shape as the interfaces 226, and each recess 366A and 366B has a diameter that is slightly smaller than the diameter of the interfaces 226. This encourages a secure mechanical and electrical connection between the electrical connector 360 and any of the interfaces 226.

Each housing 344, 364 is an insulating housing and is made of any electrically insulating material. For example, the housings 344, 364 may be made of ethylene propylene diene monomer (EPDM) rubber, any rubber material, silicone, a polymer, a hardened or solidified foam, and/or hardened epoxy. A conductive shield (not shown) may surround an outer surface of each housing 344, 364. In implementations that include a shield, the shield may be made of any electrically conductive or semiconductive material. For example, the shield may be made of cured EPDM doped with an electrically conductive material, and the conductive shield may be grounded. The connector 340 and the connector 360 may be implemented with or without a conductive shield. In some implementations, the connector 360 is a 600 A, 15 kV or 600 A, 25 kV class CLEER loadbreak connector, both of which are available from the Eaton Corporation of Cleveland, Ohio.

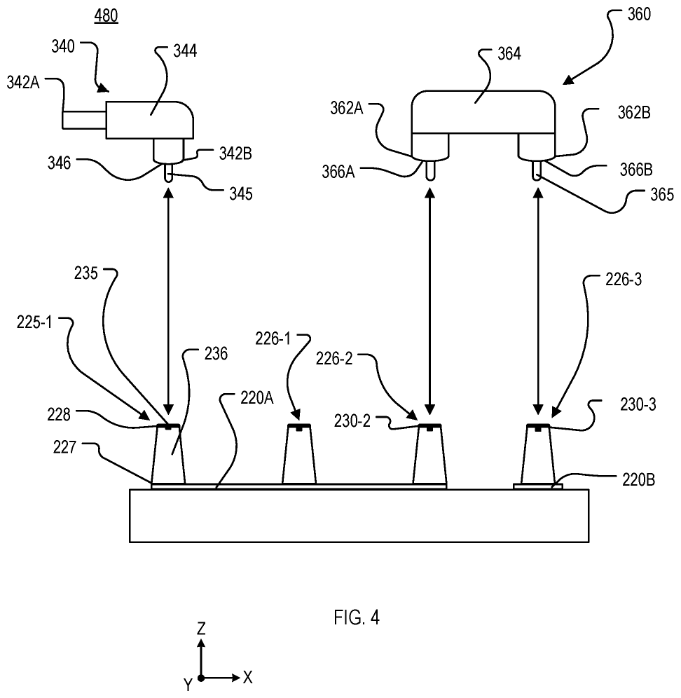

Referring also to FIG. 4, an example of connecting the first and second type of separable electrical connectors 340 and 360 to the switching apparatus 222 is discussed. The recess 346 of the first type of separable electrical connector 340 is pushed in the —Z direction onto the end 228 the first type interface 225-1. When the first type interface 225-1 is fully inserted into the recess 346, the electrical connector 340 is mechanically secured to the first type interface 225-1 and the conductor 345 is electrically connected to the conductor 235. Thus, the conductor 345 is also electrically connected to the busbar 220A. The first type interface 225-1 may be held in the recess 346 of the electrical connector 340 by a frictional engagement between the electrically insulating housing 236 and the wall of the recess 346.

Other and/or additional mechanical connections between the first type interfaces 225 and the separable electrical connector 340 are possible. For example, in implementations in which the electrical connector 340 is a loadbreak connector, the end 342A of the housing 344 may include an internal latch groove that surrounds the recess 346. In these implementations, the interface 225 includes an external protrusion that fits into the latch groove to secure the electrical connector 340 to the interface. In another example, in implementations in which the electrical connector 340 is a deadbreak connector, the recess 346 may include internal threads that mate with corresponding threads on the interface 225.

The second type of separable electrical connector 360 is attached to the second type interfaces 226-2 and 226-3. The recess 366A is placed over the end 230-2 of the interface 226-2 and pushed onto the interface 226-2. Similarly, the recess 366B is placed over the end 230-3 of the interface 226-3 and pushed onto the interface 226-3. When the interface 226-2 is fully inserted into the recess 366A, the connector 360 is mechanically secured to the interface 226-2 and the conductor 365 is electrically connected to the busbar 220A. When the interface 226-3 is fully inserted into the recess 366B, the connector 360 is mechanically secured to the interface 226-3 and the conductor 365 is electrically connected to the busbar 220B.

The arrangement of the interfaces 226 on the surface 223 allows the electrical connector 360 to be mechanically and electrically connected to adjacent second type interfaces on different busbars (such as the interfaces 226-2 and 226-3) at the same time. Thus, the electrical connector 360 may be used to establish an electrical connection between two distinct busbars (the busbars 220A and 220B in this example). In other words, the switching apparatus 222 is configured such that the second type of separable electrical connector 360 may be used to electrically connect distinct busbars.

FIGS. 5A-5C show various current paths through the switching apparatus 222. In the example shown in FIGS. 5A-5C, the switching apparatus 222 is used with at least four instances of the first type of separable connector 340 and three instances of the second type of separable connector 360. The four instances of the separable connector 340 are separable connectors 540-1, 540-2, 540-3, and 540-4. The three instances of the separable connector 360 are separable connectors 560-1, 560-2, and 560-3.

FIG. 5A shows the switching apparatus 222 in the standard mode. The first type of separable electrical connector 540-1 is connected to the first type interface 225-1 and to the source 102 such that the source 102 is electrically connected to the busbar 220A. The conductor of each interface 226-1, 226-2 is electrically connected to the source 102 via the busbar 220A. The electrical connector 560-1 is connected to the interface 226-1 and to the interface 226-6. The conductor of the electrical connector 560-1 electrically connects the busbar 220A and the busbar 220D. The interface 225-2 is connected to the electrical connector 540-2 and to the device 110 such that the conductor of the electrical connector 540-2 electrically connects the busbar 220D and the device 110. The electrical connector 540-3 is connected to the interface 225-3 and to the device 110 such that conductor of the electrical connector 540-3 electrically connects the busbar 220C and the device 110. The electrical connector 560-2 is connected to the interface 226-5 and the interface 226-4 such that the conductor of the electrical connector 560-2 electrically connects the busbars 220C and 220B. The electrical connector 540-4 is connected to the interface 225-2 and to the load 103 such that the load is electrically connected to the busbar 220B.

Thus, in the configuration shown in FIG. 5A, the connectors 540-1, 540-2, 540-3, 540-4 and the connectors 560-1, 560-2, and 560-3 are attached to the switching apparatus 222 to provide a current path from the source 102 to the device 110 and to the load 103. In other words, in the configuration shown in FIG. 5A, the device 110 is electrically connected to the source 102 and the load 103.

FIG. 5B shows an example of the switching apparatus 222 in a make-before-break transition mode before transitioning to the bypass mode (FIG. 5C). The arrangement of the connectors 540-1, 540-2, 540-3, 540-4 and the connectors 560-1, 560-2 is the same as in the standard mode (FIG. 5A), but an additional connector 560-3 is attached to the interfaces 226-2 and 226-3. The conductor of the connector 560-3 electrically connects the busbar 220A and the busbar 220B. This arrangement results in two current paths through the switching apparatus 222 between the source 102 and the load 103. The first current path is the current path from the source 102 to the device and to the load 103 that is discussed above with respect to FIG. 5A. The second current path is the current path from the source 102 to the load 103 via the busbar 220A, the conductor of the connector 560-3, and the busbar 220B.

The second current path generally has a much lower impedance than the first current path (which includes the device 110), and most or all of the current that flows between the source 102 and the load 103 flows in the second current path. Thus, although the device 110 is electrically connected to the first current path, very little or no current flows to the device 110.

In some implementations, the second current path does not necessarily have a lower impedance than the first current path due to the device 110 itself having a low impedance. However, the switching apparatus 222 may be used to bypass such devices. A voltage regulator is an example of a device 110 that does not necessarily have a high internal impedance in all configurations. In implementations in which the device 110 has a low impedance in some or all conditions, the operator of the device 110 and/or switching apparatus 222 takes steps to increase the impedance of the device 110 prior to placing the switching apparatus 222 in the make-before-break mode to protect the device 110 and ensure a successful bypass. For example, in the case of the voltage regulator, the operator moves the regulator to the neutral position prior to placing the switching apparatus 222 in the make-before-break mode.

FIG. 5C shows the switching apparatus 222 in the bypass mode. The switching apparatus 222 is converted from the transition mode (shown in FIG. 5B) to the bypass mode by removing the connector 560-1 from the interfaces 226-1 and 226-6 and removing the connector 560-2 from the interfaces 226-5 and 226-4. Removing the connector 560-1 electrically isolates the busbar 220A from the busbar 220D. Removing the connector 560-2 electrically isolates the busbar 220C from the busbar 220B.

After the connectors 560-1 and 560-2 are removed, the only current path through the switching apparatus 222 is the second current path. As discussed above, the second current path electrically connects the source 102 to the load 103 via the busbar 220A, the conductor of the connector 560-3, and the busbar 220B. The second current path is a bypass current path that does not include the device 110. Thus, the device 110 is bypassed and the source 102 remains connected to the load 103. Additionally, because the second current path is formed before breaking the first current path, the device 110 is disconnected from the source 102 and load 103 under a no-load condition, prolonging the life of the device 110. After the switching apparatus 222 is placed in the bypass mode, the connectors 540-2 and 540-3 may be removed from the interfaces 225-4 and 225-3, respectively, to allow the device 110 to be relocated away from the switching apparatus 222. Because there is no current flowing to the device 110, arcing does not occur during disconnection.

In sum, the switching apparatus 222 is a make-before-break bypass switch that is configurable to connect to the device 110 or to bypass the device 110 based on the arrangement of the separable connectors 540-1, 540-2, 540-3, 540-4 and 560-1, 560-2, 560-3. Each of the connectors 560-1, 560-2, 560-3 are configured to attach to two interfaces and are used to electrically connect two otherwise electrically isolated busbars to thereby define one or more current paths in and/or through the switching apparatus 222.

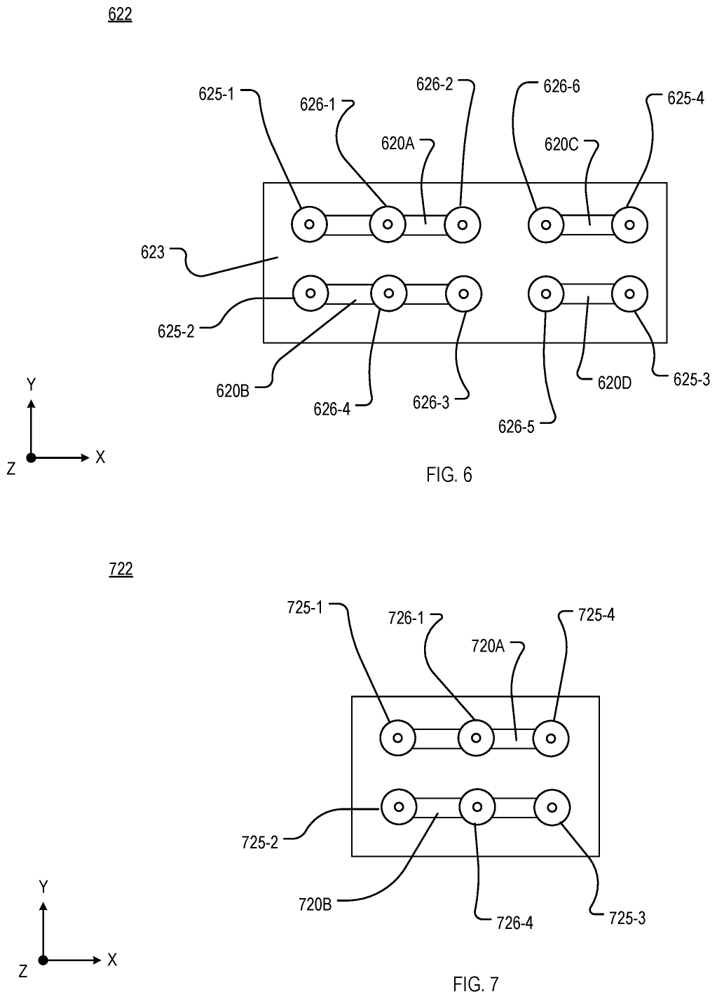

FIG. 6 is a block diagram of a switching apparatus 622. The switching apparatus 622 is an example of another implementation of the switching apparatus 222.

The switching apparatus 622 includes busbars 620A, 620B, 620C and 620D. The busbars 620A, 620B, 620C and 620D are attached to a surface 623 and are electrically isolated from each other. The busbars 620A-620D include first and second type interfaces arranged such that the switching apparatus 622 is a configurable make-before-break bypass switching apparatus.

The busbar 620A is a three-way junction that includes a first type interface 625-1 and second type interfaces 626-1 and 626-2. The busbar 620B is a three-way junction that includes a first type interface 625-2 and second type interfaces 626-3 and 626-4. The busbar 620C is a two-way junction that includes a first type interface 625-4 and a second type interface 626-6. The busbar 620D is a two-way junction that includes a first type interface 625-3 and a second type interface 626-5.

Each busbar 620A-620D is an electrically conductive body that extends in the X direction. The busbars 620A and 620B are parallel to each other and separated in the Y direction. The busbars 620A and 620C are aligned in the X direction and separated from each other in the X direction. The busbars 620C and 620D are parallel to each other and separated from each other in the Y direction. The busbars 620B and 620D are aligned in the X direction separated from each other in the X direction.

Each first type interface 625-1 to 625-4 is configured for attachment to a first type of separable electrical connector (such as the electrical connector 340). Each second type interface 626-1 to 626-6 is positioned such that two adjacent second type interfaces on different busbars may be attached to the same second type of separable electrical connector (such as the electrical connector 360). In the example shown, the second type interface 626-1 and 626-4 are adjacent, the second type interface 626-2 is adjacent to the second type interface 626-3 and the second type interface 626-6, the second type interface 626-3 is adjacent to the second type interface 626-5 and to the second type interface 626-2, and the second type interface 626-5 is adjacent to the second type interface 626-6.

To use the switching apparatus 622 in the standard mode, a second type separable electrical connector is attached to the interfaces 626-2 and 626-6 such that the busbars 620A and 620C are electrically connected. Another second type separable electrical connector is attached to the interfaces 626-3 and 626-5 such that the busbars 620B and 620D are electrically connected. Each interface 625-1 to 625-4 is electrically connected to an external device via a first type separable electrical connector (such as the electrical connector 340) as follows: the interface 625-1 is connected to the source 102, the interface 625-3 is connected to the device 110, the interface 625-4 is also connected to the device 110, and the interface 625-2 is connected to the load 103.

In preparation for transitioning the switching apparatus 622 to the bypass mode, an additional second type of separable electrical connector is attached to the interfaces 626-1 and 626-4. This electrically connects the busbars 620A and 620B and creates two current paths through the switching apparatus 622. The first current path is from the source 102 to the load 103 through the device 110. The second current path is from the source 102 to the load 103 through the interfaces 626-1 and 626-4. The second current path bypasses the device 110. The second current path has a much lower impedance than the first current path.

To transition the switching apparatus 622 to the bypass mode, the second type of separable electrical connectors are removed from the interfaces 626-2 and 626-6 and the interfaces 626-3 and 626-5. The interfaces 626-1 and 626-4 remain connected to a single second type of separable electrical connector. Thus, the busbars 620A and 620B remain electrically connected to each other, and the busbars 620A and 620B are electrically isolated from the busbars 620C and 620D. In other words, only the second current path from the source 102 to the load 103 that bypasses the device 110 remains and the switching apparatus 622 is now configured in the bypass mode.

FIG. 7 is a block diagram of a switching apparatus 722. The switching apparatus 722 shows an example implementation with fewer components than the switching apparatuses 222 and 622.

The switching apparatus 722 includes two electrically isolated busbars 720A and 720B. Each busbar 720A, 720B is a three-way junction. The busbar 720A includes first type interfaces 725-1 and 725-4 that are on either side of a second type interface 726-1. The busbar 720B includes first type interfaces 725-2 and 725-3 that are on either side of a second type interface 726-4. Each first type interface 725-1 to 725-4 is configured for attachment to a first type of separable electrical connector (such as the electrical connector 340). The second type interfaces 726-1 and 726-4 are positioned adjacent to each other such that a second type of separable electrical connector (such as the electrical connector 360) can be attached to the interface 726-1 and the interface 726-4 at the same time.

The switching apparatus 722 can be configured in standard mode by electrically connecting interfaces 725-1 to 725-4 to external devices via a first type of separable electrical connectors (such as the electrical connector 340) as follows: the interface 725-1 is connected to the source 102, the interface 725-3 is connected to a device 110, the interface 725-4 is also connected to the device 110, and the interface 725-2 is connected to a load 103.

To transition the switching apparatus 722 into a bypass mode, a second type of separable electrical connector (such as the electrical connector 360) is attached to the interfaces 726-1 to 726-4, thereby electrically connecting the busbars 720A and 720B and creating a second current path between the source 102 and the load 103. The second current path bypasses the device 110 and has a low impedance such that device 110 is bypassed. Other implementations are possible. For example, the switching apparatus 722 may be configured for use in a system that is rated at 200 A. In these implementations, an electrically conductive jumper cable may be used instead of a C-shaped or U-shaped separable electrical connector.

Any of the switching apparatuses 122, 222, 622, and 722 discussed above may have additional features. For example, any of the switching apparatuses 122, 222, 622, and 722 may include compartments or bays that provide additional separation and isolation between the busbars. FIG. 8 is a block diagram of a switching apparatus 822 that includes compartments or bays.

The switching apparatus 822 is the same as the switching apparatus 222, except the switching apparatus 822 includes bays 851-1, 851-2, 851-3, and 851-4. The busbar 220A is in the bay 851-1, the busbar 220B is in the bay 851-2, the busbar 220C is in the bay 851-3, and the busbar 220D is in the bay 851-4. The bays are formed by walls 850-1, 850-2, 850-3, and 850-4 that extend from the surface 223 in the Z direction. The bay 851-1 is formed by the wall 850-1 and part of the wall 850-2. The bay 851-2 is formed by the wall 850-2. The bay 851-3 is formed by the wall 850-3 and part of each of walls 850-2 and 850-1. The bay 851-4 is formed by the wall 850-3, the wall 850-4, and part of the wall 850-1. The walls 850-1, 850-2, 850-3, and 850-4 may be made of an electrically insulating material, such as, for example, a polymer or a metal that is coated in an electrically insulating material.

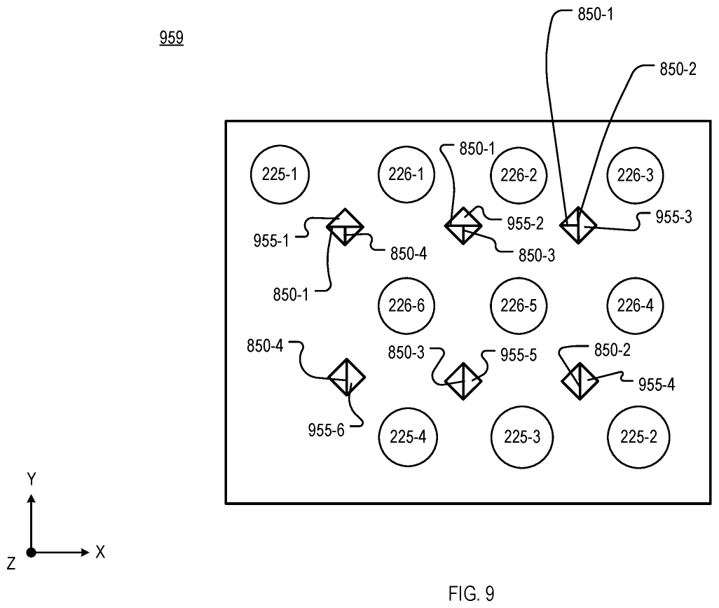

The walls 850-1, 850-2, 850-3, and 850-4 are barriers between the various busbars 220A-220D and provide additional electrical isolation. Additionally, the intersections of the walls 850-1, 850-2, 850-3, 850-4 may be used as visible indicators, as discussed with respect to FIG. 9.

FIG. 9 shows an example of a switching apparatus cover 959 placed over the switching apparatus 222. The first type interfaces 225 and the second type interfaces 226 extend through the cover 959 such that the various separable electrical connectors may be attached to and removed from the interfaces 225 and 226 according to the application of the switching apparatus 222.

The switching apparatus cover 959 also includes openings 955-1, 955-2, 955-3, 955-4, 955-5, and 955-6 (collectively the openings 955). When the cover 959 is mounted on the switching apparatus 222, each opening 955 is placed over an intersection point of two or more of the walls 850-1, 850-2, 850-3, 850-4. For example, when the cover 959 is placed on the switching apparatus 222, the opening 955-1 is positioned over the intersection or meeting point of the walls 850-1 and 850-4 so that the user sees the intersection even if the cover is made of an opaque material.

The openings 955 provide a visible indicator of electrical connections between the busbars 220A-220D. For example, the wall 850-1 that extends in the X direction and is visible through the openings 955-1, 955-2, 955-3 indicates that the interfaces 255-1, 262-1, and 262-2 are in the same bay (the bay 851-1) and are on the same busbar (the busbar 220A). However, the opening 955-1 also shows only part of the wall 850-4, indicating that the interface 226-2 is not on the busbar 220A and is not electrically connected to the busbar 220A unless a separable electrical connector is used to connect the interfaces 626-1 and 626-6.

The openings 955 are provided as an example, and a visible indicator may take other forms. For example, in some implementations, markings on the surface of the switching apparatus cover 959 that follow the walls 850-1, 850-2, 850-3, and 850-4 are used instead of openings. Similar covers may be used on the switching apparatuses 622 and 722.

These and other implementations are within the scope of the claims. Moreover, other implementations are possible. For example, the interfaces 225 and 226 discussed above include housings or bushings configured for connection to a separable electrical connector. However, in some implementations, the interfaces are openings, junctions, receptacles, mounting points, or any other type of attachment point to which a bushing configured to connect to a separable electrical connector may be mounted or secured.

What is claimed is:

1. A system comprising:
a switching apparatus comprising a plurality of electrically isolated busbars, each busbar comprising at least a first interface and a second interface;
a first type of separable electrical connector configured to mechanically and electrically connect to one of the first interfaces; and
a second type of separable electrical connector configured to connect to two of the second interfaces simultaneously; wherein
the switching apparatus is configurable to have one of a plurality of current paths based on which two of the second interfaces are electrically and mechanically connected to the second type of separable electrical connector.

2. The system of claim 1, further comprising a base portion, the base portion being an electrically conductive material, and wherein the plurality of busbars are attached to the base portion and are electrically isolated from the base portion.

3. The system of claim 2, wherein the base portion comprises a plurality of bays, and each busbar is in a separate bay.

4. The system of claim 3, wherein each bay is defined by walls that extend from the base portion.

5. The system of claim 4, wherein the system further comprises a cover portion configured for placement over the bays, the cover portion comprising a plurality of openings; and when the cover portion is placed over the bays, at least some of the openings are over intersection points of the walls to thereby provide a visible indicator of the current path.

6. The system of claim 1, wherein the second type of electrical connector comprises:
a first electrical probe;
a second electrical probe;
an electrical conductor that electrically connects the first electrical probe and the second electrical probe; and
an insulating housing defining a first connector interface and a second connector interface, wherein the first connector interface is configured to attach to one of the second interfaces of the switching apparatus to thereby electrically connect the first electrical probe to a first one of the second interfaces; and the second connector interface is configured to attach to a second one of the second interfaces of the switching apparatus to thereby electrically connect the second electrical probe to the second one of the second interfaces and to electrically connect the busbar that includes the first one of the second interfaces to the busbar that includes second one of the second interfaces.

7. The system of claim 6, wherein the second type of electrical connector is a C-shape or a U-shape electrical connector.

8. The system of claim 6, wherein the first type of electrical connector is an elbow arrester.

9. The system of claim 1, further comprising an electrically insulating material between each busbar.

10. The system of claim 1, wherein the plurality of current paths comprise: a standard current path that connects a device to a source and a load; a transition current path that provides a low-impedance current path between the source and the load and a high-impedance current path to the device; and a bypass current path that connects the source to the load without being connected to the device.

11. The system of claim 1, wherein the first interface is a deadbreak interface configured to connect to a separable deadbreak connector or a loadbreak interface configured to connect to a loadbreak connector.

12. The system of claim 11, wherein the first interface and the second interface are rated to conduct current of up to 200 Amperes (A), current up to 600 A, or current of up to 1250 A.

13. The system of claim 1, wherein the first interface is a deadbreak bushing.

14. The system of claim 13, wherein the second interface is rated to conduct current of up to 200 A or up to 600 A.

15. The system of claim 1, wherein the plurality of busbars comprises a first busbar, a second busbar, a third busbar, and a fourth busbar; the first busbar, the second busbar, the third busbar, and the fourth busbar are arranged such that the second electrical connector is attachable to more than one adjacent pair of second interfaces, and two second interfaces that are nearest to each other form an adjacent pair of second interfaces.

16. The system of claim 1, wherein the plurality of busbars comprises first and second busbars; and each of the first and second busbars comprises two first interfaces and one second interface.

17. The system of claim 1, wherein the plurality of busbars comprises a first busbar, a second busbar, a third busbar, and a fourth busbar; each of the first and second busbars comprises one first interface and two second interfaces; and each of the third and fourth busbars comprises one first interface and one second interface.

18. A switching apparatus comprising:
a base portion;
a first electrical conductor attached to the base portion; and
a second electrical conductor attached to the base portion and electrically isolated from the first electrical conductor, wherein each of the first electrical conductor and the second electrical conductor is electrically isolated from the base portion, each of the first electrical conductor and the second electrical conductor comprises: at least one first type interface configured to electrically and mechanically connect to a first type of separable electrical connector, and at least one second type interface configured to electrically and mechanically connect to a second type of separable electrical connector; and
the switching apparatus is configurable to have one of a plurality of current paths based on which of the second type interfaces are electrically and mechanically connected to a second type of separable electrical connector.

19. The switching apparatus of claim 18, wherein the plurality of current paths comprise: a standard current path that connects a device to a source and a load; a transition current path that provides a low-impedance current path between the source and the load and a high-impedance current path to the device; and a bypass current path that connects the source to the load without being connected to the device.

20. The switching apparatus of claim 18, wherein the switching apparatus further comprises a third electrical conductor attached to the base portion and electrically isolated from the base portion, the third electrical conductor comprising at least one of the first type interface and at least one of the second type interface; and a fourth electrical conductor attached to the base portion and electrically isolated from the base portion, the fourth electrical conductor comprising at least one of the first type interface and at least one of the second type interface.

21. The switching apparatus of claim 18, wherein the first interface comprises a first bushing, and the second interface comprises a second bushing.

22. The switching apparatus of claim 18, wherein the first electrical conductor is a first busbar, and the second electrical conductor is a second busbar.

23. A method comprising:
electrically connecting a source to a switch assembly by connecting a first separable electrical connector to a first type interface on a first electrical conductor;
electrically connecting a load to the switch assembly by connecting a second separable electrical connector to a first type interface on a second electrical conductor;
electrically connecting a device between the source and the load by connecting a third electrical connector and a fourth electrical connector to the switch assembly, wherein connecting the third electrical connector to the switch assembly comprises connecting the third electrical connector a second type interface on the first electrical conductor and to a second type interface on a third electrical conductor, and connecting the fourth electrical connector to the switch assembly comprises connecting the fourth electrical connector to a second type interface on a fourth electrical conductor and to a second type interface on the second electrical conductor; and
bypassing the device, the bypassing comprising:
connecting a fifth electrical connector to a second type interface on the first electrical conductor to a second type interface on the second electrical conductor; and
after connecting the fifth electrical connector, disconnecting the third electrical connector and the fourth electrical connector from the switch assembly.
